(19) United States
(12) Patent Application Publication
(10) Pub. No.: US 2019/0095212 A1
(43) Pub. Date: Mar. 28, 2019

(54) NEURAL NETWORK SYSTEM AND OPERATING METHOD OF NEURAL NETWORK SYSTEM

(71) Applicant: SAMSUNG ELECTRONICS CO., LTD., Suwon-si (KR)

(72) Inventor: SEUNG-SOO YANG, Hwaseong-si (KR)

(21) Appl. No.: 16/039,730

(22) Filed: Jul. 19, 2018

(30) Foreign Application Priority Data
Sep. 27, 2017 (KR) 10-2017-0125410

(51) Int. Cl. G06F 9/38; G06N 3/02; G06K 9/00

(52) U.S. Cl. CPC G06F 9/38; G06K 9/00744; G06N 3/02

(57) ABSTRACT

A neural network system is configured to perform a parallel-processing operation. The neural network system includes a first processor configured to generate a plurality of first outputs by performing a first computation based on a first algorithm on input data, a memory storing a first program configured to determine a computing parameter in an adaptive manner based on at least one of a computing load and a computing capability of the neural network system; and a second processor configured to perform the parallel-processing operation to perform a second computation based on a second algorithm on at least two first outputs from among the plurality of first outputs, based on the computing parameter.

### CROSS-REFERENCE TO RELATED APPLICATION

This application claims priority under 35 U.S.C. 119 to Korean Patent Application No. 10-2017-0125410, filed on Sep. 27, 2017, in the Korean Intellectual Property Office, the disclosure of which is incorporated by reference in its entirety herein.

### BACKGROUND

### 1. Technical Field

The inventive concept relates to a neural network, and more particularly, to a neural network system that processes a hybrid algorithm, and an operating method of the neural network system.

### 2. Discussion of Related Art

A neural network refers to a computational scientific architecture modeled based on a biological brain. Due to recent developments in neural network technology, studies have been actively performed to analyze input data and extract effective information by using a neural network device using one or more neural network models in various types of electronic systems.

Neural network models may include a deep learning algorithm. A neural network model may be executed in a neural network system. The neural network system may perform a computation based on a neural network model. However, a processing speed of current neural network systems is quite low. Thus, there is a need for an increase in a processing speed of a neural network system.

### SUMMARY

At least one embodiment of the inventive concept provides a neural network system capable of increasing a processing speed of a hybrid algorithm, and an operating method of the neural network system. Thus, when the neural network system is implemented on a computer for performing one or more of its operations, at least one embodiment of the inventive concept can improve the functioning of the computer.

According to an exemplary embodiment of the inventive concept, there is provided a method of operating a neural network system including a computing device for performing a hybrid computation. The method includes the computing device performing a first computation on a first input for generating a plurality of first outputs, the computing device determining a computing parameter based on computing information of the system, the computing device determining N candidates from the first outputs based on the computing parameter (i.e., N>=2) and the computing device performing a second computation on the N candidates by performing a parallel-processing operation on the N candidates using a neural network model.

According to an exemplary embodiment of the inventive concept, there is provided a method of operating a neural network system including a computing device for performing a hybrid computation. The method includes the computing device generating a plurality of computation inputs by pre-processing received input information, the computing device determining computing information of the system periodically; the computing device determining a batch mode of a neural network model in an adaptive manner based on the computing information, the computing device determining N candidates from the computation inputs based on the batch mode (i.e., N>=2), and the computing device performing a parallel-processing operation on the N candidates using the neural network model.

According to an exemplary embodiment of the inventive concept, there is provided a neural network system to perform a parallel-processing operation. The neural network system includes a first processor configured to generate a plurality of first outputs by performing a first computation based on a first algorithm on input data, a memory storing a first program configured to determine a computing parameter in an adaptive manner based on at least one of a computing load and a computing capability of the neural network system, and a second processor configured to perform the parallel-processing operation to perform a second computation based on a second algorithm on at least two first outputs from among the plurality of first outputs, based on the computing parameter.

According to an exemplary embodiment of the inventive concept, a neural network system is provided for processing image data to determine an object. The system includes an image sensor configured to capture an image, a video recognition accelerator to extract regions of interest from the image to generate a plurality of candidate images, and a processor performing a parallel-processing operation on a subset of the candidate images using a neural network model to generate computation results indicating whether the object is present.

### BRIEF DESCRIPTION OF THE DRAWINGS

Embodiments of the inventive concept will be more clearly understood from the following detailed description taken in conjunction with the accompanying drawings in which:

FIG. 1 is a block diagram of an electronic system, according to an exemplary embodiment of the inventive concept;

FIG. 2A illustrates a hybrid computation, according to an exemplary embodiment of the inventive concept, and FIG. 2B illustrates an input/output of a second computation;

FIGS. 3A and 3B are block diagrams illustrating examples of a hybrid computing module, according to an exemplary embodiment of the inventive concept;

FIG. 4 illustrates an example of an operation of the hybrid computing module, according to an exemplary embodiment of the inventive concept;

FIG. 5 is a flowchart of an operating method of a neural network system, according to an exemplary embodiment of the inventive concept;

FIG. 6A illustrates a neural network model applied to a hybrid computation, according to an exemplary embodiment of the inventive concept, and FIG. 6B illustrates an example of the neural network model of FIG. 6A;

FIG. 7 illustrates inputs and outputs of a neural network computation according to an operating method of a neural network device according to an exemplary embodiment of the inventive concept, and a comparative example;

FIGS. 8A and 8B illustrate examples in which a size of an input of a neural network model is changed in a neural network computation based on parallel-processing, according to embodiments of the inventive concept;

FIG. 9 illustrates a relation between a neural network input and second inputs when a size of an input of a neural network model is changed;

FIGS. 10A and 10B illustrate examples in which the number of an instance of a neural network model is changed in a neural network computation based on parallel-processing, according to exemplary embodiments of the inventive concept;

FIGS. 11A and 11B illustrate examples in which a batch mode is changed in a neural network computation based on parallel-processing, according to exemplary embodiments of the inventive concept;

FIG. 12 is a diagram for describing a neural network computation based on an batch mode;

FIG. 13 is a block diagram of a processor that executes a neural network model;

FIG. 14 illustrates an example of a neural network system, according to an exemplary embodiment of the inventive concept;

FIG. 15 is a diagram for describing a hybrid computation performed in the neural network system of FIG. 14;

FIG. 16 is a flowchart of an operating method of the neural network system of FIG. 14 according to an exemplary embodiment of the inventive concept;

FIG. 17 is a flowchart of an example embodiment of operations S24, S25 and S26 in the flowchart of FIG. 16;

FIG. 18 is a block diagram of a hybrid computing module that is implemented as software, according to an exemplary embodiment of the inventive concept; and

FIG. 19 is a block diagram of an autonomous driving system, according to an exemplary embodiment of the inventive concept.

### DETAILED DESCRIPTION OF THE EXEMPLARY EMBODIMENTS

Hereinafter, exemplary embodiments of the inventive concept will now be described in detail with reference to the accompanying drawings.

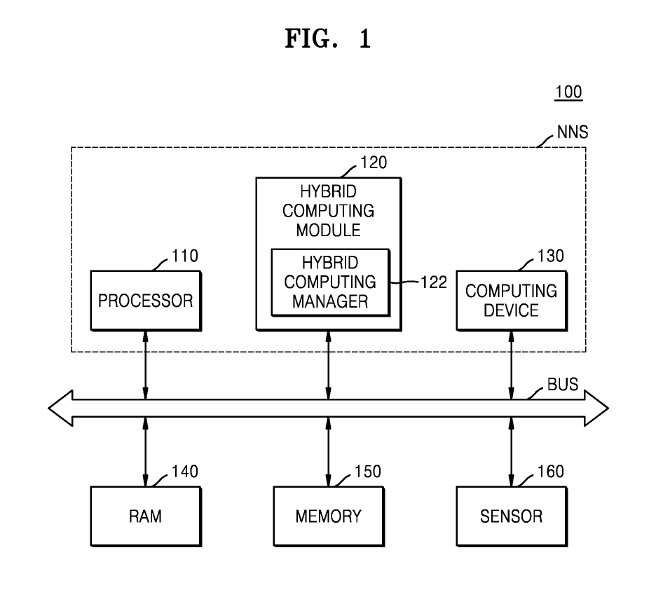

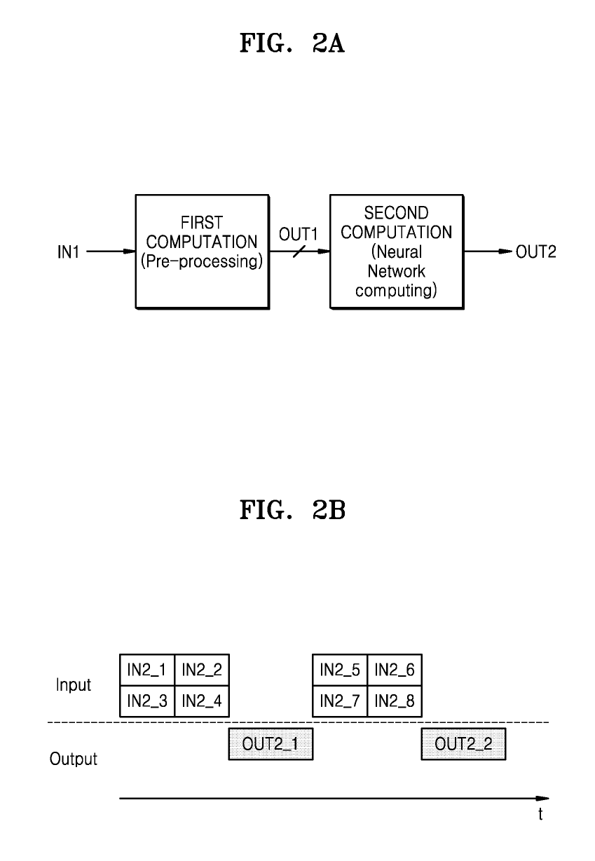

FIG. 1 is a block diagram of an electronic system 100, according to an exemplary embodiment of the inventive concept. FIG. 2A illustrates a hybrid computation, according to an exemplary embodiment of the inventive concept, and FIG. 2B illustrates an input/output of a second computation.

The electronic system 100 of FIG. 1 may extract effective information by analyzing input data in real time based on a neural network. The electronic system 100 may analyze the effective information to determine state information. Further, the electronic system 100 may control elements of an electronic device mounted in the electronic system 100 based on the determined state information.

In an embodiment, the electronic system 100 of FIG. 1 is an application processor (AP) located within a mobile device. Alternatively, the electronic system 100 of FIG. 1 may correspond to a computing system or may correspond to a drone, a robot device such as Advanced Drivers Assistance Systems (ADAS), a smart television (TV), a smartphone, a medical apparatus, a mobile device, an image display apparatus, a measuring device, an Internet of Things (IoT) device, or the like. Hereinafter, it is assumed that the electronic system 100 of FIG. 1 corresponds to an AP.

Referring to FIG. 1, the electronic system 100 includes a processor 110, a hybrid computing module 120, a computing device 130, random access memory (RAM) 140, a memory 150, and a sensor 160. The processor 110, the hybrid computing module 120, the computing device 130, the RAM 140, the memory 150, and the sensor 160 may exchange data with each other via a bus. In the present embodiment, at least some elements from among elements of the electronic system 100 may be mounted on a semiconductor chip.

The electronic system 100 may be defined to include a neural network system NNS in that the electronic system 100 performs a neural network computing function. The neural network system NNS may include at least some elements from among elements included in the electronic system 100, the at least some elements being associated with a neural network operation. In the present embodiment, referring to FIG. 1, the neural network system NNS includes the processor 110, the hybrid computing module 120, and the computing device 130, but the inventive concept is not limited thereto. For example, other various types of elements associated with the neural network operation may be arranged in the neural network system NNS.

The processor 110 controls general operations of the electronic system 100. The processor 110 may include a single core processor or a multi-core processor. The processor 110 may process or execute programs and/or data stored in the memory 150. In the present embodiment, the processor 110 may control functions of the hybrid computing module 120 and the computing device 130 by executing the programs stored in the memory 150.

In an embodiment, the hybrid computing module 120 generates an information signal by performing a hybrid-computing operation on input data, based on a hybrid algorithm. In an embodiment, the hybrid algorithm includes a hardware-based first algorithm (or a first operation) and a software-based second algorithm (or a second operation). In an embodiment, the second algorithm is a neural network model (or neural network operation) including a deep learning algorithm. The neural network model may include, but is not limited to, various types of models such as Convolutional Neural Networks (CNN), Recurrent Neural Networks (RNN), Deep Belief Networks, and Restricted Boltzmann Machines. The first algorithm may be another data processing algorithm, for example, a pre-processing algorithm executed in a pre-processing stage of a computation based on a neural network model (hereinafter, referred to as the neural network computation).

The hybrid computing module 120 may be defined as a neural network-based hybrid computing platform in which a hybrid computation is performed on input data based on the hybrid algorithm. In an embodiment, the first algorithm and the second algorithm are executed in the computing device 130, and the hybrid computing module 120 controls the computing device 130 or provides computing parameters (or operation parameters) to the computing device 130 to allow the computing device 130 to smoothly execute the first algorithm and the second algorithm. In an exemplary embodiment, the hybrid computing module 120 includes the first algorithm and/or the second algorithm and provides the first algorithm and/or the second algorithm to the computing device 130.

The information signal may include one of various types of recognition signals including a voice recognition signal, an object recognition signal, a video recognition signal, or a biological information recognition signal. In an embodiment, the hybrid computing module 120 performs a hybrid computation based on frame data included in a bitstream (e.g., a stream of bits), thereby generating a recognition signal with respect to an object included in the frame data. For example, the frame data may include a plurality of frames of image data that are to be presented on a display device. However, the inventive concept is not limited thereto. Thus, the hybrid computing module 120 may generate an information signal with respect to various types of input data, based on a neural network model, according to a type or a function of an electronic device in which the electronic system 100 is mounted.

Referring to FIG. 2A, a hybrid computation may include a first computation and a second computation. The first computation may be performed based on the first algorithm (or the first operation), i.e., the pre-processing algorithm, and the second computation may be performed based on the second algorithm (or the second operation), i.e., the neural network model including the deep learning algorithm. The first computation may be referred to as a pre-processing, and the second computation may be referred to as a neural network computation. As described above, the first algorithm and the second algorithm are executed in the computing device 130 such that the first computation and the second computation are performed.

The first computation is performed on a first input, i.e., input data, such that a plurality of first outputs OUT1 are generated and provided as a plurality of inputs, e.g., a plurality of second inputs (refer to IN2_1 through IN2_8 of FIG. 2B), with respect to the second computation. The second computation, i.e., a neural network computation, may be performed on the plurality of second inputs, so that at least one second output OUT2 is output. The at least one second output OUT2 may be an information signal or a value for deriving the information signal.

Referring to FIG. 2B, when the second computation is performed on the plurality of second inputs (refer to IN2_1 through IN2_8 of FIG. 2B), the second computation is parallel-performed on at least two of the second inputs. For example, as illustrated in FIG. 2B, four second inputs IN2_1 through IN2_4 and IN2_5 through IN2_8 may be parallel-processed.

Referring to FIG. 2B, the second inputs IN2_1 through IN2_4 are parallel-processed such that one second output OUT2 _1 is generated, and the second inputs IN2_5 through IN2_8 are parallel-processed such that one second output OUT2 _2 is generated, but the inventive concept is not limited thereto, thus, four second outputs may be generated. In an embodiment, the computing device 130 includes multiple cores that enable the computing device 130 to process data in a parallel manner. For example, a first one of the cores could perform the first computation that generates inputs IN2_1 through IN2_4, and separate bus lines may be connected from the first core to second, third, fourth, and fifth cores so that the first core can simultaneously output input IN2_1 to the second core, input IN2_2 to the third core, input IN2_3 to the fourth core and input IN2_4 to the fifth core, and then the second through fifth cores can operate in parallel on their respective inputs to generate intermediate outputs, and one of these cores or another core can generate a single second output OUT2_1 from the intermediate outputs.

Referring back to FIG. 1, the hybrid computing module 120 may include a hybrid computing manager 122. The hybrid computing manager 122 may provide computing parameters to the computing device 130 to enable the first algorithm and the second algorithm to be smoothly executed, or may control the computing device 130.

In an exemplary embodiment, the hybrid computing manager 122 determines a computing environment based on computing information, and determines computing parameters for a computation based on the second algorithm (i.e., the neural network computation) in an adaptive manner with respect to the computing environment. That is, the computing parameters may be dynamically changed according to the computing environment. For example, the computing information may include a computing load and a computing capability of the electronic system 100 (or the neural network system NNS). The computing parameters may include a size of inputs of a neural network model (e.g., a certain number of bytes), the number of the inputs, the number of instances of the neural network model, or a batch mode of the neural network model. The number of second inputs that are parallel-processed during the second computation may be determined based on the computing parameters. For example, when any one of the size of the inputs of the neural network model, the number of inputs, the number of instances, and the number of inputs of the batch mode is increased, the number of second inputs that are parallel-processed may be increased.

The hybrid computing module 120 may be implemented in various forms. According to an exemplary embodiment, the hybrid computing module 120 is implemented as software. However, the hybrid computing module 120 is not limited thereto, thus, the hybrid computing module 120 may be embodied as hardware or a combination of hardware and software. For example, the hybrid computing module 120 could be implemented as a processor or as a microprocessor including memory storing a program that it is executed by a processor of the microprocessor to execute functions of the hybrid computing module 120 and/or the hybrid computing manager 122

In an exemplary embodiment, the hybrid computing module 120 is implemented as software in an operating system (OS) or a layer therebelow, and generates an information signal by being executed by the processor 110 and/or the computing device 130. That is, the processor 110 and/or the computing device 130 may execute the hybrid computing module 120 so that a hybrid algorithm-based calculation is executed to generate the information signal from the input data. Examples of operating systems can be modified to include the hybrid computing module 120 include Microsoft Windows™, macOS™, Linux, Android™, iOS™, and Tizen™. A computer running this modified operating system may execute operations more quickly than a conventional computer.

The computing device 130 may perform the first computation based on the first algorithm and the second computation based on the second algorithm on the received input data, under control of the hybrid computing module 120. As described above, the first algorithm may be the pre-processing algorithm, and the second algorithm may be the neural network model.

The pre-processing algorithm may be used to remove irrelevant information or noisy and unreliable data. For example, the pre-processing algorithm can include steps of data cleansing, instance selection, normalization, transformation, and feature selection.

The data cleansing may including detecting and correcting corrupt or inaccurate records from a record set, table, or database. For example, the data cleansing can identify incomplete, incorrect, inaccurate, or irrelevant parts of the data and then replace, modify, or delete the dirty or coarse data.

The instance selection can be applied to removing noisy instances of data before applying learning algorithms. For example, the optimal output of instance selection would be the minimum data subset that can accomplish the same task with no performance loss, in comparison with the performance achieved when the tasks is performed using the whole available data.

The reduction of data to any kind of canonical form may be referred to as data normalization. For example, data normalization can be applied to the data during the pre-processing to provide a limited range of values so a process expecting the range can proceed smoothly.

Data transformation is the process of converting data from one format or structure into another format or structure. For example, a particular data transformation can be applied to the data during the pre-processing to convert the data into a format understood by a process that is to operate on the transformed data.

Feature extraction starts from an initial set of measured data and builds derived values (features) intended to be informative and non-redundant, thereby facilitating subsequent learning. For example, when the input data to an algorithm is too large to be processed and it is suspected to be redundant, then it can be transformed into a reduced set of features (a feature vector). Determining a subset of the initial features is referred to as feature selection. The subset is expected to contain the relevant information from the input data, so that a subsequent process can be performed using this reduced representation instead of the complete initial data.

The computing device 130 may include at least one processor, and the first algorithm and the second algorithm may be executed by homogeneous or heterogeneous processors. A system that includes heterogeneous processor includes more than one kind of processor or core. The computing device 130 may include a central processing unit (CPU), a graphics processing unit (GPU), a numeric processing unit (NPU), a digital signal processor (DSP), or a field programmable gate array (FPGA). For example, the NPU could be a coprocessor that performs floating point arithmetic operations, graphics operations, signal processing operations, etc. In an exemplary embodiment, the first algorithm is executed by a dedicated processor. Alternatively, the first algorithm may be embodied as hardware to be one of the processors included in the computing device 130.

The computing device 130 may generate an information signal based on a computation result. The computing device 130 may include one or more processors (e.g., the dedicated processor) for performing a hybrid calculation based on a hybrid algorithm. In addition, the computing device 130 may include a separate memory (not shown) for storing executable programs or data structures corresponding to neural network models.

The RAM 140 may temporarily store programs, data, or instructions. For example, programs and/or data stored in the memory 150 may be temporarily stored in the RAM 140, by the control of the processor 110 or a booting code. The RAM 140 may be embodied as a memory such as dynamic ram (DRAM) or static RAM (SRAM).

The memory 150 may store control instruction code for controlling the electronic system 100, control data, or user data. The memory 150 may include at least one of a volatile memory and a non-volatile memory.

The sensor 160 may sense an internal signal or an external signal of the electronic system 100, and may provide, to the computing device 130, data generated due to the sensing as input data for the hybrid computation. The sensor 160 may include an image sensor, an infrared sensor, a camera, a touch sensor, an illumination sensor, an acoustic sensor, an acceleration sensor, a steering sensor, or a bio-sensor. However, the sensor 160 is not limited thereto, and may be one of various types of sensors to generate input data requested according to functions of the electronic system 100.

As described above, in the electronic system 100 according to an exemplary embodiment, the hybrid computing manager 122 of the hybrid computing module 120 dynamically changes the computing parameters, based on the computing load and the computing capability which are variable according to time.

In an embodiment, the computing capability refers to at least one of the processing capacity of a CPU, the storage capacity of a memory, or a bandwidth of data transmission. In an embodiment, the computing capability includes at least one of an amount of usable power, amounts of usable hardware resources (e.g., 50 megabytes of memory available, 2 cores available for use, etc.), a system power state (e.g., in power save mode, in standby mode, in normal mode), and a remaining quantity of a battery (e.g., 20% battery left).

In an embodiment, the computing load is a CPU load, a memory load, or a bandwidth load. In an embodiment, the computing load indicates how overloaded the system is (e.g., 73% overloaded since a certain number of processes had to wait for a turn for a single CPU on average), how idle the system is (e.g., CPU was idle 40% of the time on average), or an uptime (measure of time that a system is available to perform work). For example, a variable representative of the computing load can be incremented each time a process is using or waiting for a CPU and then decremented whenever a process using or waiting for the CPU is terminated. The computing load may be based on at least one of a number of inputs provided to the neural network model, a dimension of these inputs, a capacity and power of a memory required for processing based on the neural network model, and a data processing speed required by the neural network model. The computing device 130 may perform a parallel process based a neural network model, in an adaptive manner with respect to the computing environment, so that a neural network computation speed is increased. Thus, the performance of the electronic system 100 or the neural network system NNS may be enhanced.

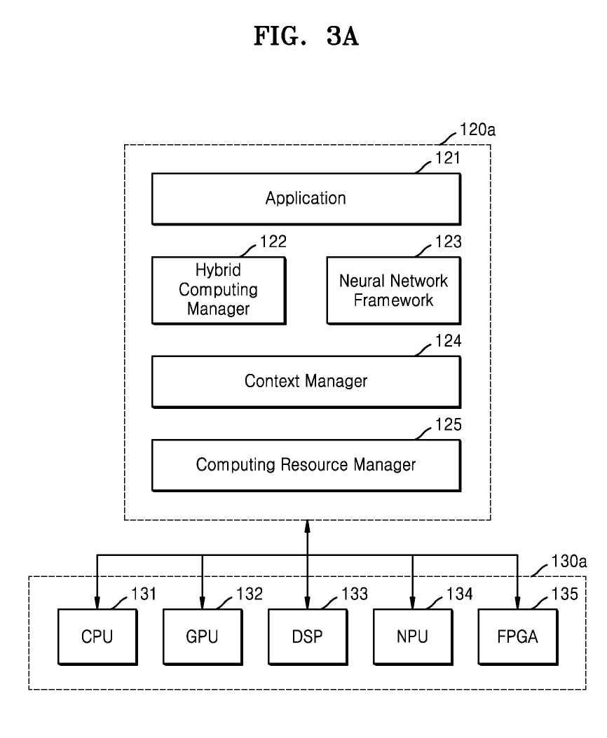

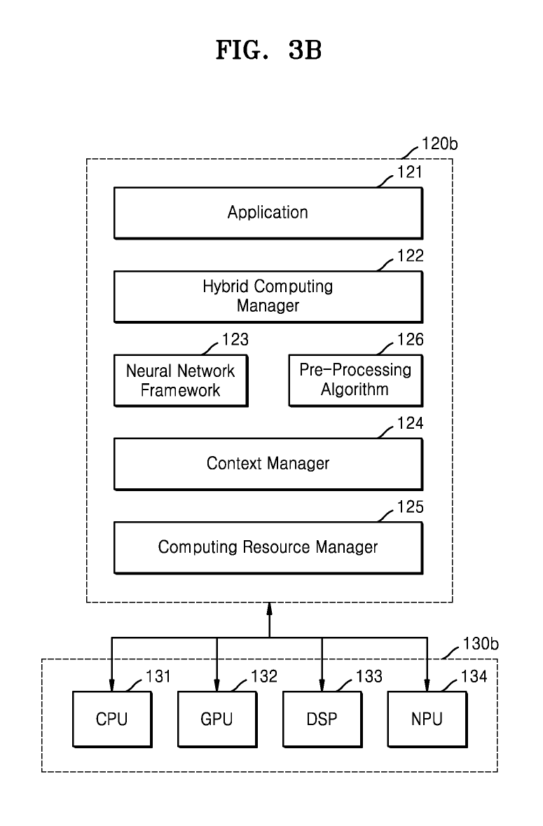

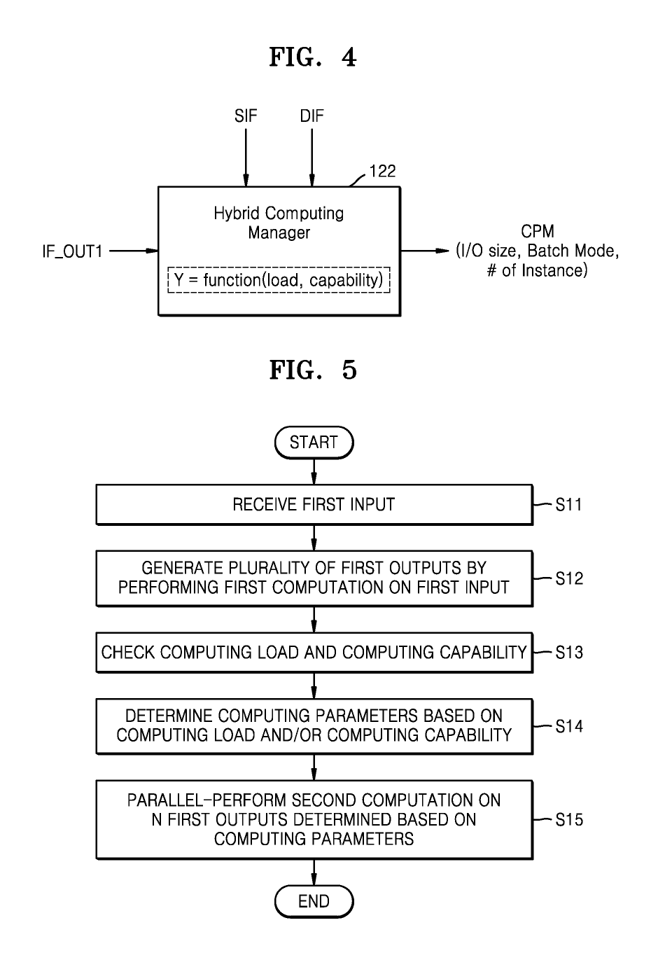

FIGS. 3A and 3B are block diagrams illustrating examples of a hybrid computing module, according to embodiments of the inventive concept. FIG. 4 illustrates an example of an operation of the hybrid computing module, according to an exemplary embodiment of the inventive concept. For detailed descriptions, FIGS. 3A and 3B also illustrate computing devices 130a and 130b, respectively. Hybrid computing modules 120a and 120b of FIGS. 3A and 3B are examples of the hybrid computing module 120 of FIG. 1, thus, descriptions provided above with reference to FIGS. 1 through 2B may be applied to the present embodiments.

Referring to FIG. 3A, the hybrid computing module 120a includes an application 121, the hybrid computing manager 122, a neural network framework 123, a context manager 124, and a computing resource manager 125.

The application 121 may be an application program that executes a function requiring a hybrid computation including a neural network computation. For example, the application 121 may be a camera-dedicated application program that tracks an object (e.g., a face, a road, a line, etc.) included in a captured image. However, the application 121 is not limited thereto and may be various types of application programs.

The hybrid computing manager 122 may control a hybrid computing process. As described above, the hybrid computing manager 122 may determine computing parameters (refer to CPM of FIG. 4) for a computation based on a neural network model.

Referring to FIG. 4, the hybrid computing manager 122 may determine in real time a computing load and a computing capability based on dynamic information DIF and static information SIF with respect to a computing environment and a result of the first computation (i.e., first output information IF_OUT1), may determine computing parameters CPM in an adaptive manner with respect to the computing environment based on the computing load and/or the computing capability or may change computing parameters CPM that were previously determined. The computing parameters CPM may include a size of inputs of the neural network model, the number of the inputs, the number of instances of the neural network model, or a batch mode of the neural network model (e.g., the number of inputs of the batch mode).

The static information SIF may include a plurality of pieces of basic information of various elements in the electronic system 100. For example, the static information SIF may include computing resource information about a function and characteristic of hardware that executes the neural network model (or a neural network algorithm). The dynamic information DIF includes a plurality of pieces of information which may occur while the neural network model is executed. For example, the pieces of information may include computing context information in a runtime process. The first output information IF_OUT1 may include a size (or a dimension) of first outputs or the number of the first outputs.

In an exemplary embodiment, the hybrid computing manager 122 includes a determining function or an algorithm which uses the computing load and the computing capability as an input, and generates a variable determination value Y based on the computing load and the computing capability which vary. The hybrid computing manager 122 may determine or change the computing parameters CPM, based on the determination value Y. In an exemplary embodiment, the hybrid computing manager 122 includes a look-up table in which the computing parameters CPM are variously set based on variable values of the computing load and the computing capability, and determines the computing parameters CPM by accessing the look-up table.

The hybrid computing manager 122 may provide the computing parameters CPM to a processor that performs a neural network computation from among processors included in the computing device 130a. Alternatively, the hybrid computing manager 122 may control the processor that performs a neural network computation, based on the computing parameters CPM.

The neural network framework 123 includes a neural network model including a deep learning algorithm. For example, the neural network model may include Convolution Neural Network (CNN), Region with Convolution Neural Network (R-CNN), Recurrent Neural Network (RNN), Stacking-based deep Neural Network (S-DNN), Exynos DNN, State-Space Dynamic Neural Network (S-SDNN), Caffe, or TensorFlow. The neural network framework 123 may include various pieces of information including a layer topology such as a depth and branch of the neural network model, information about a compression method, information about a computation at each layer (e.g., data property information including sizes of an input and output, a kernel/a filter, a weight, a format, security, padding, stride, etc.), or a data compression method. The neural network model provided from the neural network framework 123 may be executed by the computing device 130a. In an exemplary embodiment, a neural network system (refer to the neural network system NNS of FIG. 1) does not perform re-training. Accordingly, the neural network model may maintain its sameness.

The context manager 124 may manage dynamic information generated in a process of executing a hybrid algorithm, and may provide the dynamic information to the hybrid computing manager 122. Various states or information related to performing a neural network computation during runtime may be managed by the context manager 124, for example, information about output accuracy, latency, and frames per second (FPS), or information about an allowable accuracy loss managed by the application 121 may be provided to the hybrid computing manager 122 via the context manager 124. With the dynamic information related to runtime, dynamic information related to resources, e.g., various types of information including a change in a state of computing resources, power/temperature information, bus/memory/storage states, a type of an application, or a lifecycle of the application may be provided to the hybrid computing manager 122 via the context manager 124.

The computing resource manager 125 may determine various types of static information. For example, the computing resource manager 125 may determine capacity information about performance and power consumption of the hardware, hardware limitation information about an unsupported data type, a data layout, compression, or a quantization algorithm. In addition, the computing resource manager 125 may determine various types of information such as computation method information of a convolution/addition/maximum value, kernel structure information, data flow information, or data reuse scheme information, as various information about hardware (e.g., dedicated hardware) for better acceleration.

Referring to FIG. 3A, the computing device 130a includes a CPU 131, a GPU 132, a DSP 133, an NPU 134, and an FPGA 135, but the computing device 130a may include the FPGA 135 and at least one processor of the CPU 131, the GPU 132, the NPU 134, and the DSP 133. Alternatively, the computing device 130a may further include another type of processor.

In an exemplary embodiment, the first algorithm is embodied as hardware in the FPGA 135. A plurality of first outputs generated by performing, by the FPGA 135, a first computation based on the first algorithm on input data may be provided to another processor, e.g., one of the CPU 131, the GPU 132, the NPU 134, and the DSP 133. For example, if it is assumed that the GPU 132 performs a neural network computation, the first outputs from the FPGA 135 may be transmitted to the GPU 132. The GPU 132 may parallel-perform the neural network computation, based on computing parameters provided by the hybrid computing manager 122 or under the control of the hybrid computing manager 122. According to an exemplary embodiment of the inventive concept, the hybrid algorithm (i.e., the first algorithm and the second algorithm) is performed by at least two pieces of appropriate hardware, so that a processing speed with respect to the hybrid algorithm is improved.

Referring to FIG. 3B, the hybrid computing module 120b includes the application 121, the hybrid computing manager 122, the neural network framework 123, the context manager 124, the computing resource manager 125, and a pre-processing algorithm 126. Compared to the hybrid computing module 120a of FIG. 3A, the hybrid computing module 120b further includes the pre-processing algorithm 126.

The pre-processing algorithm 126 may be the first algorithm for pre-processing input data before a first computation, e.g., a neural network computation is performed, and may be implemented as software. The pre-processing algorithm 126 may be executed by one of the processors of the computing device 130b, e.g., one of the CPU 131, the GPU 132, the NPU 134, and the DSP 133. In the present embodiment, the pre-processing algorithm and the neural network model may be executed by homogeneous or heterogeneous processors.

FIG. 5 is a flowchart of an operating method of a neural network system, according to an exemplary embodiment of the inventive concept. The operating method of FIG. 5 may be performed by the neural network system NNS of FIG. 1.

Referring to FIG. 5, a first input is received (S11). The first input may be input data and may be provided from the sensor 160 (refer to FIG. 1). The first input may include video data of at least one frame, voice data, or touch data (e.g., coordinates of a touch). For example, the computing device 130 may receive the first input.

A plurality of first outputs are generated by performing a first computation on the first input (S12). For example, the computing device 130 may perform the first computation on the first input based on a first algorithm that is implemented as hardware or software, thereby generating the plurality of first outputs. The plurality of first outputs may mutually have a same size. The plurality of first outputs may include two-dimensional (2D) or three-dimensional (3D) data. Each of the plurality of first outputs may be provided as an input for a second computation, i.e., a neural network computation. Thus, each first output may be referred to as a second input or a computation input.

A computing load and a computing capability are checked (S13). The hybrid computing manager 122 may check the computing load and the computing capability, based on static information, dynamic information, and first output information. The computing load and the computing capability may vary in real time. In addition, whenever the first computation, i.e., S12, is performed, information about first outputs may be changed. For example, the number of a plurality of first outputs may be provided as the first output information. The number of the plurality of first outputs may be changed whenever the first computation is performed. Thus, the hybrid computing manager 122 may check the computing load and the computing capability in a periodic manner or after the first computation is performed.

Computing parameters are determined based on the computing load and/or the computing capability (S14). In the present embodiment, the hybrid computing manager 122 adaptively determines the computing parameters to enable the neural network system NNS to have optimal performance in a computing environment based on the computing load and the computing capability. In response to a change in the computing load and the computing capability, the computing parameters may be dynamically determined, i.e., changed. As described above, the computing parameters may include a size of inputs of a neural network model, the number of the inputs, the number of instances of the neural network model, or a batch mode of the neural network model. In an exemplary embodiment, the computing parameters are determined based on one of the computing load and the computing capability, i.e., based on at least one index from among indexes indicating the computing load and the computing capability.

A second computation is parallel-performed on N first outputs (where N is an integer that is equal to or greater than 2) determined based on the computing parameters (S15). A number N of first outputs to be parallel-processed may be determined based on the computing parameters. Thus, when the computing parameters are changed, the number N of first outputs may also be changed. For example, the number N of first outputs to be parallel-processed may be determined based on a size of inputs of a neural network model, the number of the inputs, the number of instances of the neural network model, and a batch mode of the neural network model.

The computing device 130 may parallel-perform the second computation on the N first outputs that are determined based on the computing parameters, i.e., N second inputs.

In an exemplary embodiment, the first computation and the second computation may be executed by homogeneous or heterogeneous processors from among a plurality of processors included in the computing device 130. When the first computation and the second computation are executed by the heterogeneous processors, the plurality of first outputs are transmitted to a processor to perform the second computation.

In an exemplary embodiment, the first computation is performed by the processor 110, and the processor 110 (refer to FIG. 1) transmits the plurality of first outputs to the computing device 130 (i.e., the processor that is from among processors included in the computing device 130 and is to perform the second computation).

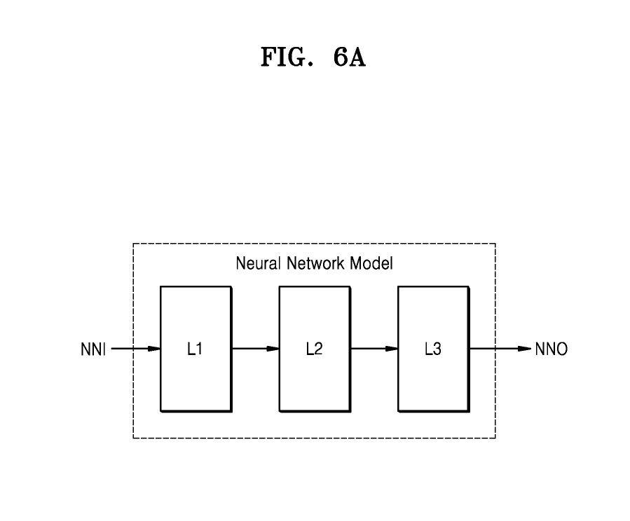

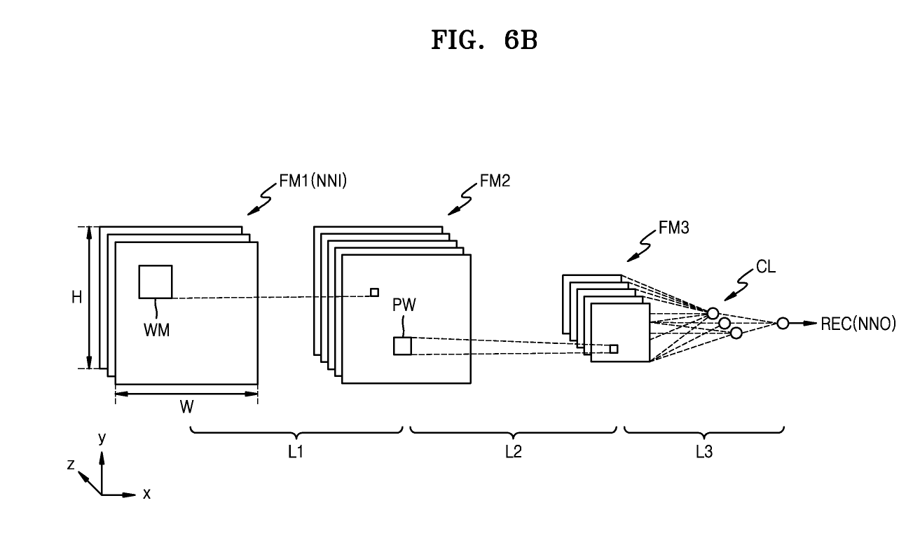

FIG. 6A illustrates a neural network model applied to a hybrid computation, according to an exemplary embodiment, and FIG. 6B illustrates an example of the neural network model of FIG. 6A.

Referring to FIG. 6A, the neural network model is a deep neural network including a plurality of layers L1, L2, and L3 (also referred to as the first, second, and third layers L1, L2, and L3). While three layers L1, L2, and L3 are shown in FIG. 6A, the inventive concept is not limited thereto and thus a number and types of the layers may vary according to implemented neural network models. Other layers such as the second layer L2 excluding an input layer (e.g., the first layer L1) and an output layer (e.g., the third layer L3), from among the plurality of layers L1, L2, and L3 may be referred to as a hidden layer.

Homogeneous or heterogeneous calculations may be performed at the plurality of layers L1, L2, and L3. When an input NNI of the neural network model (hereinafter, referred to as the neural network input NNI) is provided to the first layer L1, at least one sub operation (or at least one sub computation) according to the first layer L1 may be performed on the neural network input NNI at the first layer L1, and an output from the first layer L1 may be provided to the second layer L2. At least one sub operation according to the second layer L2 may be performed on the output from the first layer L1 at the second layer L2, and an output from the second layer L2 may be provided to the third layer L3. At least one sub operation according to the third layer L3 may be performed on the output from the second layer L2 at the third layer L3, and an output from the third layer L3 may be output as an output NNO of the neural network model (hereinafter, referred to as the neural network output NNO).

Referring to FIG. 6B, the first layer L1 may be a convolution layer, the second layer L2 may be a pooling layer, and the third layer L3 may be the output layer. The output layer may be a fully-connected layer. The neural network model may further include an active layer, and in addition to layers shown in FIG. 6B, another convolution layer, another pooling layer, or another fully-connected layer may be further included. The neural network input NNI and the outputs from the plurality of layers L1, L2, and L3 may each be referred to as a feature map or a feature matrix.

Each of the plurality of layers L1, L2, and L3 may receive the neural network input NNI or a feature map generated in a previous layer, as an input feature map, may calculate the input feature map, and thus may generate an output feature map or a recognition signal REC. In this regard, a feature map refers to data in which various features of the neural network input NNI are expressed. Feature maps FM1, FM2, and FM3 (also referred to as first, second, and third feature maps FM1, FM2, and FM3) may have a form of a 2D matrix or a 3D matrix (or referred to as a tensor). The feature maps FM1, FM2, and FM3 may have a width W (also referred to as a column) and a height H (also referred to as a row), and may additionally have a depth. These may respectively correspond to an x-axis, a y-axis, and a z-axis on coordinates. In this regard, the depth may be referred to as a channel number.

At the first layer L1, the first feature map FM1 is convolved with a weight map WM, so that the second feature map FM2 is generated. In an embodiment, the weight map WM filters the first feature map FM1 and may be referred to as a filter or a kernel. At the second layer L2, a size of the second feature map FM2 may be decreased based on a pooling window PW, such that the third feature map FM3 is generated. Pooling may be referred to as sampling or down-sampling.

At the third layer L3, features of the third feature map FM3 may be combined to classify a class CL of the neural network input NNI. Also, the recognition signal REC corresponding to the class CL is generated. In an exemplary embodiment, when input data is a frame image included in a videostream, classes corresponding to objects included in the frame image are extracted at the third layer L3. Afterward, a recognition signal REC corresponding to a recognized object may be generated.

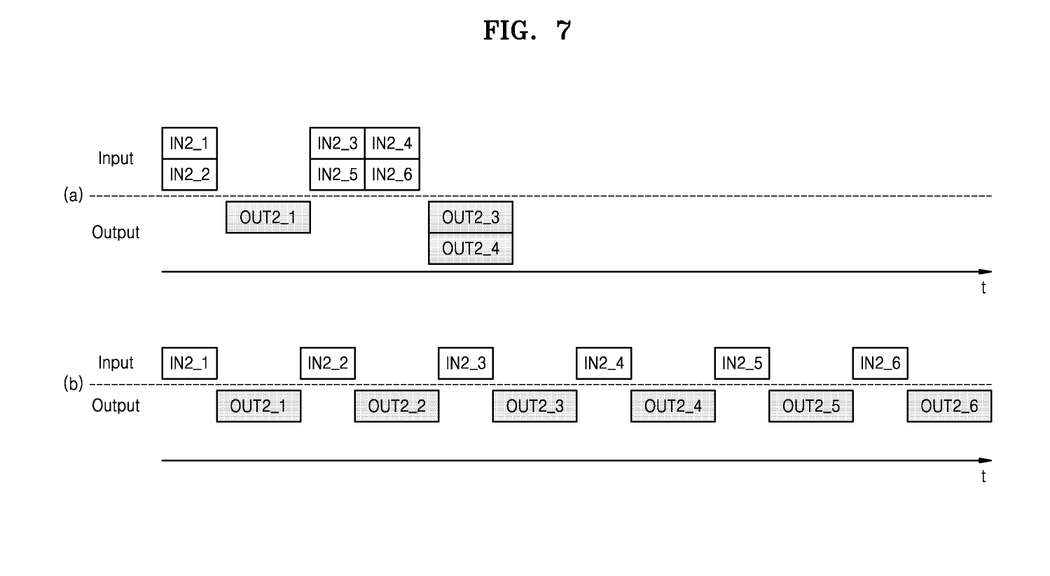

FIG. 7 illustrates inputs and outputs of a neural network computation according to an operating method of a neural network device according to an exemplary embodiment, and a comparative example. Section (a) of FIG. 7 illustrates inputs and outputs of the neural network computation based on parallel-processing according to an exemplary embodiment of the inventive concept, and section (b) of FIG. 7 illustrates inputs and outputs of the neural network computation based on sequential-processing.

Referring to section (a) of FIG. 7, at least two second inputs (e.g., second inputs IN2_1 and IN2_2, and second inputs IN2_2 through IN2_4) from among a plurality of second inputs IN2_1 through IN2_6 are parallel-computed based on a neural network model. The number of second inputs that are parallel-processed may vary based on a computing environment of a neural network system, e.g., a computing load and a computing capability. A size of a second output of a case in which at least two second inputs are parallel-processed and thus one second output is generated may be greater than a size of a second output of a case in which one second input is processed and then one second output is generated.

Referring to section (b) of FIG. 7, when the plurality of second inputs IN2_1 through IN2_6 are sequentially processed, a time taken to process the plurality of second inputs IN2_1 through IN2_6 is longer than a time taken to parallel-process the at least two second inputs according to the exemplary embodiment shown in section (a) of FIG. 7.

Thus, according to the operating method of a neural network device according to an exemplary embodiment of the inventive concept (i.e., according to the neural network computation based on parallel-processing), a processing speed of the neural network device may be increased, and the performance of the neural network device may be improved.

Hereinafter, various cases in which computing parameters (e.g., an input size of a neural network model, the number of instances of a neural network, and batch mode) are changed with respect to a neural network computation based on parallel-processing will now be described.

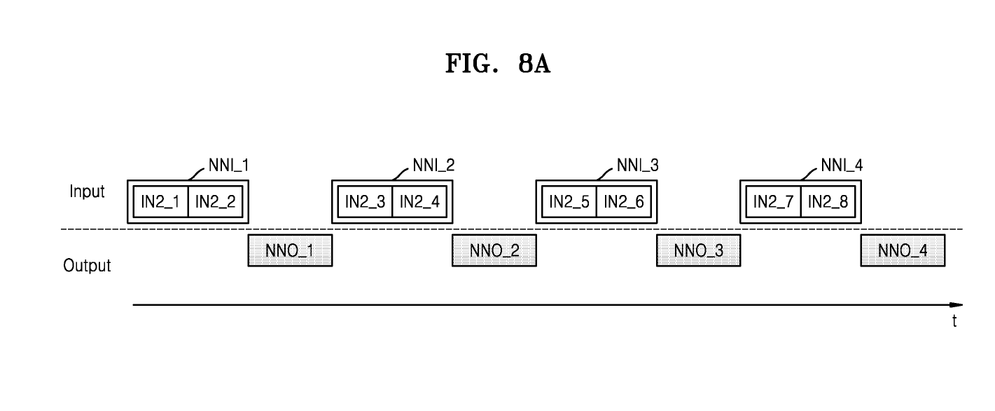

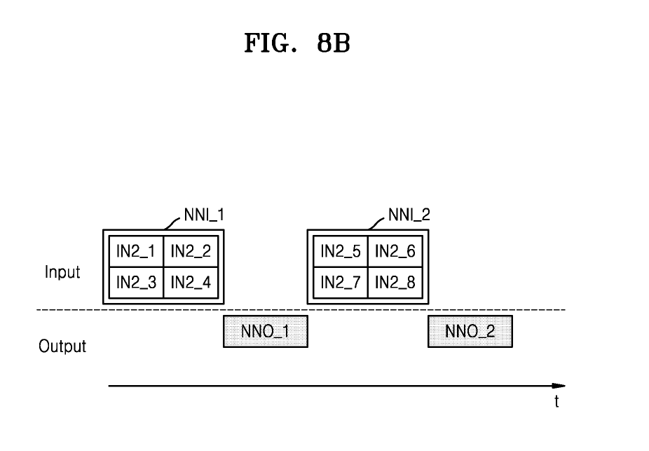

FIGS. 8A and 8B illustrate examples in which a size of an input of a neural network model is changed in a neural network computation based on parallel-processing, according to embodiments of the inventive concept.

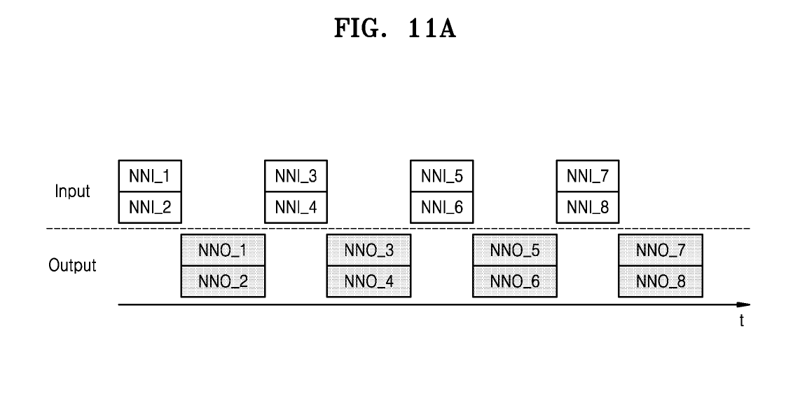

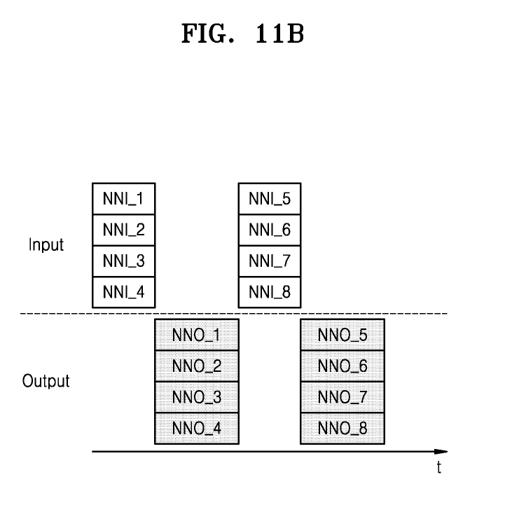

In FIGS. 8A and 8B, second inputs IN2_1 through IN2_8 indicate outputs in response to a first computation, i.e., first outputs in a hybrid computation. The second inputs IN2_1 through IN2_8 may be referred to as a computation input. Neural network inputs NNI_1 through NNI_4 indicate inputs of a neural network model that is computed based on the neural network model. That is, the neural network inputs NNI_1 through NNI_4 indicate inputs of a second computation. Neural network outputs NNO_1 through NNO_4 indicate computation results in response to a second computation (i.e., neural network computing) with respect to the neural network inputs NNI_1 through NNI_4. Referring to FIGS. 8A and 8B, the neural network inputs NNI_1 through NNI_4 are sequentially computed, but the inventive concept is not limited thereto, and as will be described below with reference to FIGS. 11A and 11B, at least two inputs from among the neural network inputs NNI_1 through NNI_4 may be parallel-computed.

Referring to FIGS. 8A and 8B, a size of each of the neural network inputs NNI_1 through NNI_4 may be K times (where K is an integer equal to or greater than 2) a size of each of the second inputs IN2_1 through IN2_8, i.e., first outputs, and the size of the neural network inputs NNI_1 through NNI_4 may be changed.

Referring to FIG. 8A, the size of each of the neural network inputs NNI_1 through NNI_4 may be twice as large as the size of each of the second inputs IN2_1 through IN2_8. Accordingly, two second inputs may be provided as one neural network input. A size of each of the neural network outputs NNO_1 through NNO_4 may be changed in proportion to the size of each of the neural network inputs NNI_1 through NNI_4. The size of each of the neural network outputs NNO_1 through NNO_4 of FIG. 8A may be twice as large as the size of each of the neural network outputs NNO_1 through NNO_4 when the size of each of the neural network inputs NNI_1 through NNI_4 is equal to the size of each of the second inputs IN2_1 through IN2_8.

Referring to FIG. 8B, the size of each of the neural network inputs NNI_1 through NNI_4 may be four times as large as the size of each of the second inputs IN2_1 through IN2_8. Accordingly, four second inputs may be provided as one neural network input. For example, referring to FIG. 8B, the size of each of the neural network outputs NNO_1 through NNO_4 of FIG. 8B is four times as large as the size of each of the neural network outputs NNO_1 through NNO_4 when the size of each of the neural network inputs NNI_1 through NNI_4 is equal to the size of each of the second inputs IN2_1 through IN2_8, and may be twice as large as the size of each of the neural network outputs NNO_1 through NNO_4 of FIG. 8A.

As described above, the size of each of the neural network inputs NNI_1 through NNI_4 may be changed based on the computing load and/or the computing capability. For example, if the computing load is increased and the computing capability is sufficient, the size of each of the neural network inputs NNI_1 through NNI_4 may be increased. Alternatively, if the computing load is decreased, the size of each of the neural network inputs NNI_1 through NNI_4 may be decreased, considering instantaneous power consumption.

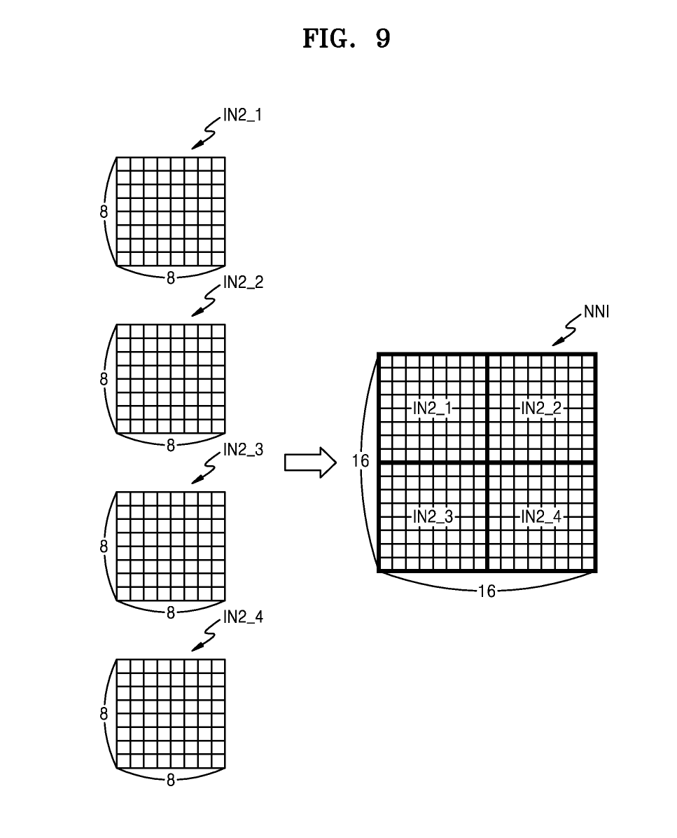

FIG. 9 illustrates a relation between a neural network input and second inputs when a size of an input of a neural network model is changed.

Referring to FIG. 9, second inputs IN2_1 through IN2_4 are 8×8 2D data. As illustrated, a size of a neural network input NNI is set to be four times as large as a size of each of the second inputs IN2_1 through IN2_4. The size of the neural network input NNI may be set as 16×16. Thus, four second inputs IN2_1 through IN2_4 are provided as the neural network input NNI and then may be computed based on the neural network model. Thus, four second inputs IN2_1 through IN2_4 may be parallel-processed. FIG. 9 illustrates an example in which the second inputs IN2_1 through IN2_4 are each 2D data, but the inventive concept is not limited thereto, as the second inputs IN2_1 through IN2_4 may each be 3D data or multi-dimensional data.

With reference to FIGS. 8A through 9, embodiments in which sizes of inputs and outputs of a neural network are changed are described. The aforementioned descriptions are exemplary embodiments. Thus, the sizes of inputs and outputs of the neural network may be variously changed.

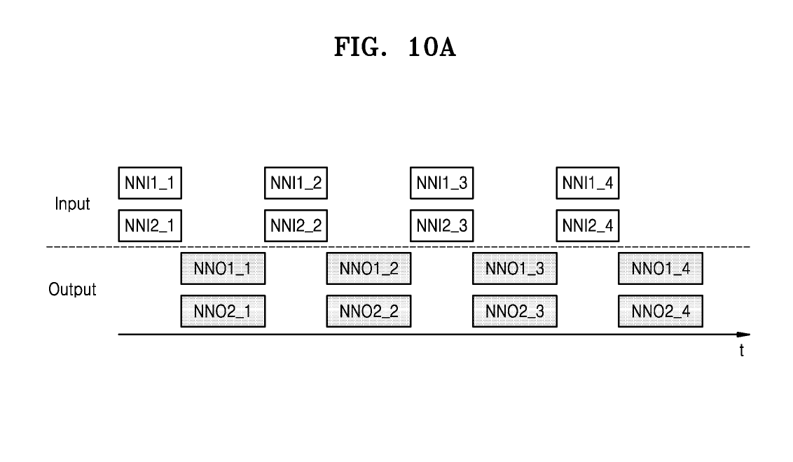

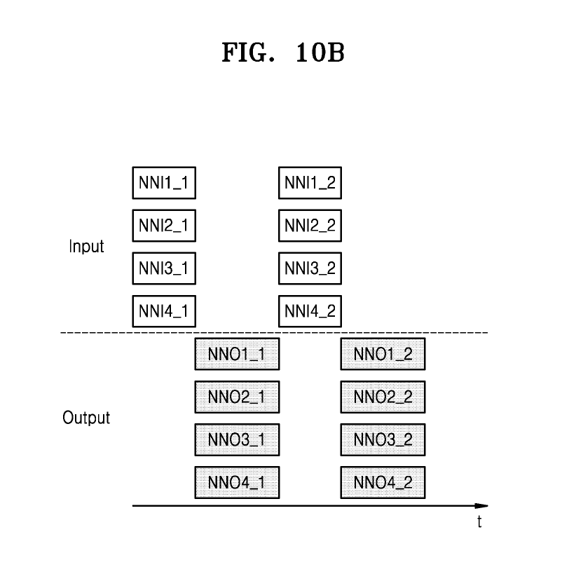

FIGS. 10A and 10B illustrate examples in which the number of instances of a neural network model is changed in a neural network computation based on parallel-processing, according to exemplary embodiments of the inventive concept. In FIGS. 10A and 10B, it is assumed that a size of each of neural network inputs NNI1_1 through NNI1_4 and NNI2_1 through NNI2_4 (also referred to as the first neural network inputs NNI1_1 through NNI1_4 and the second neural network inputs NNI2_1 through NNI2_4) is equal to a size of second inputs (i.e., outputs in response to a first computation in a hybrid computation). That is, it is assumed that each of the second inputs is provided to one of the neural network inputs NNI1_1 through NNI1_4 and NNI2_1 through NNI2_4.

Referring to FIGS. 10A and 10B, at least two neural network models may be parallel-executed. In other words, the number of instances of the neural network model may be set to be a multiple number. The number of the instances of the neural network model may be changed.

When there is one instance, one neural network model is executed, and when there are two instances, two neural network models, e.g., a first neural network model and a second neural network model, may be executed. In this regard, the first neural network model and the second neural network model are the same. That is, contents of the first neural network model and the second neural network model, e.g., operations, weights or weight maps, activation functions, or the like which are to be applied to a neural network model, are the same.

In FIG. 10A, the first neural network inputs NNI1_1 through NNI1_4 indicate inputs of the first neural network model, the second neural network inputs NNI2_1 through NNI2_4 indicate inputs of the second neural network model, first neural network outputs NNO1_1 through NNO1_4 indicate outputs of the first neural network model, and second neural network outputs NNO2_1 through NNO2_4 indicate outputs of the second neural network model. When the number of an instance of the neural network model is set as 2, two neural network models may be simultaneously executed. Thus, the first and second neural network inputs NNI1_1 and NNI2_1, NNI1_2 and NNI2_2, NNI1_3 and NNI2_3, and NNI1_4 and NNI2_4, i.e., two second inputs, are parallel-processed, such that the first and second neural network outputs NNO1_1 and NNO2_1, NNO1_2 and NNO2_2, NNO1_3 and NNO2_3, and NNO1_4 and NNO2_4 may be generated.

Referring to FIG. 10B, when the number of instances of the neural network model is set as 4, four neural network models may be simultaneously executed. Thus, first through fourth neural network inputs NNI1_1 through NNI4_1, and NNI1_2 through NNI4_2, i.e., four second inputs, may be parallel-processed, such that first through fourth neural network outputs NNO1_1 through NNO4_1, and NNO1_2 through NNO4_2 may be generated.

The number of instances of the neural network model may be changed based on a computing load and/or a computing capability. For example, if the computing load is increased and the computing capability is sufficient, the number of the instances of the neural network model may be increased. Alternatively, if the computing load is decreased or the computing capability is decreased, the number of instances of the neural network model may be decreased.

With reference to FIGS. 10A and 10B, embodiments in which the number of instances of the neural network model is changed are described. The aforementioned descriptions are exemplary embodiments. Thus, the number of instances of the neural network model may be variously changed.

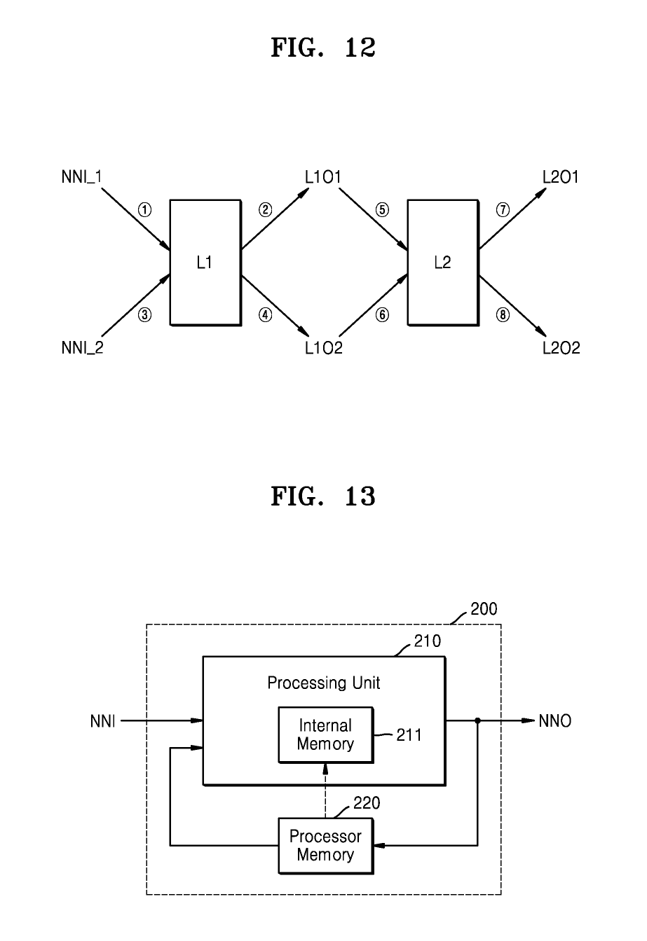

FIGS. 11A and 11B illustrate examples in which a batch mode is changed in a neural network computation based on parallel-processing, according to exemplary embodiments of the inventive concept. FIG. 12 is a diagram for describing a neural network computation based on a batch mode. In FIGS. 11A and 11B, a size of each of neural network inputs NNI_1 through NNI_8 is equal to a size of each of second inputs (i.e., outputs in response to a first computation in a hybrid computation). That is, it is assumed that each of the second inputs is provided to one of neural network inputs NNI1_1 through NNI1_4 and NNI2_1 through NNI2_4.

In the present embodiment, the batch mode (for example, a setting value of the batch mode) indicates the number of neural network inputs that are parallel-processed when one neural network model is executed. When the batch mode is set to 1, one neural network input is computed, and when the batch mode is set to 2, two neural network inputs are computed.

Referring to FIG. 11A, the batch mode is set to 2 and then two neural network inputs (e.g., the neural network inputs NNI_1 and NNI_2) are parallel-processed, such that two neural network outputs (e.g., neural network outputs NNO_1 and NNO_2) are generated. Referring to FIG. 11B, the batch mode is set to 4 and then four neural network inputs (e.g., the neural network inputs NNI_1 through NNI_4) are parallel-processed, such that four neural network outputs (e.g., neural network outputs NNO_1 through NNO_4) are generated.

Referring to FIG. 12, as described above with reference to FIGS. 6A and 6B, a neural network model may include a plurality of layers, e.g., a first layer L1 and a second layer L2. When a neural network computation based on a batch mode is performed, a first sub operation based on the first layer L1 is performed (i.e., computed) on neural network inputs NNI1 or NNI2 and then a second sub operation based on the second layer L2 is performed on first layer outputs L1O1 and L1O2.

For example, the first sub operation is performed on a neural network input NNI_1 at the first layer L1 such that the first layer output L1O1 is generated, and then the first sub operation is performed on a neural network input NNI_2 at the first layer L1 such that the first layer output L1O2 is generated.

Afterward, the second sub operation is performed on the first layer output L1O1 at the second layer L2 such that a second layer output L2O1 is generated, and then the second sub operation is performed on the first layer output L1O2 at the second layer L2 such that a second layer output L2O2 is generated. While sub operations with respect to inputs are sequentially performed at respective layers, in an entire process of the neural network computation, the neural network inputs NNI1 or NNI2 are parallel-processed. The batch mode is related to the number of neural network inputs. For example, if the batch mode is high, the number of neural network inputs may be large, and if the batch mode is low, the number of neural network inputs may be small. The batch mode may vary according to a computing load and/or a computing capability. For example, if the computing load is increased and the computing capability is sufficient, the batch mode may be set to be high. If the computing load is decreased or the computing capability is decreased, the batch mode may be set to be low.

FIG. 13 is a block diagram of a processor 200 that executes a neural network model.

The processor 200 may be one of the CPU 131, the GPU 132, the DSP 133, the NPU 134, and the FPGA 135 of FIG. 3A.

The processor 200 includes a processing unit 210 and a processor memory 220. FIG. 13 illustrates one processing unit 210 for convenience of description, but the processor 200 may include a plurality of processing units.

The processing unit 210 may be a unit circuit to perform a computation based on a layer from among a plurality of layers, e.g., the first layer L1 and the second layer L2 of FIG. 12. Thus, the processing unit 210 may sequentially perform the first sub operation and the second sub operation respectively corresponding to the first layer L1 and the second layer L2. The processing unit 210 performs (i.e., computes) the first sub operation on a neural network input NNI to generate a computation result, stores the computation result, receives the computation result as an input, and then performs the second computation on the computation result. The computation result may be stored in the processor memory 220.

In this regard, first sub operation information (or parameters) and second sub operation information (e.g., weights, weight maps, or function values), which are respectively required for the first sub operation and the second sub operation, may be stored in the processor memory 220. A capacity of an internal memory 211 may be relatively small compared to a capacity of the processor memory 220. Thus, when the processing unit 210 performs the first sub operation, the first sub operation information may be loaded to the internal memory 211, and when the processing unit 210 performs the second sub operation, the second sub operation information may be loaded to the internal memory 211. The processing unit 210 may perform a sub operation based on sub operation information loaded to the internal memory 211.

Referring to FIGS. 12 and 13, if the processing unit 210 performs the first sub operation and the second sub operation on one neural network input (e.g., the neural network input NNI_1), and then performs the first sub operation and the second sub operation on another neural network input (e.g., the neural network input NNI_2), the first sub operation information and second sub operation information have to be loaded twice to the internal memory 211.

However, as described above with reference to FIG. 12, if the first sub operation is performed on the neural network inputs NNI_1 and NNI_2 and then the second sub operation is performed on outputs from the first computation based on the batch mode, the first sub operation information and second sub operation information only need to be loaded once to the internal memory 211. Thus, when the neural network computation is performed based on the batch mode, a time taken to load a plurality of pieces of information, which are required for sub operations of respective layers, to the internal memory 211 may be reduced.

With reference to FIGS. 8A through 13, the cases in which an input size of a neural network model, the number of instances, and batch mode are each changed are described. However, the inventive concept is not limited thereto, and according to a computing environment, the input size and the number of instances of the neural network model may be changed, the input size and the batch mode of the neural network model may be changed, or the number of instances and the batch mode may be changed. Alternatively, all of the input size of the neural network model, the number of instances, and the batch mode may be changed. Computing parameters may be variously changed in an adaptive manner with respect to the computing environment.

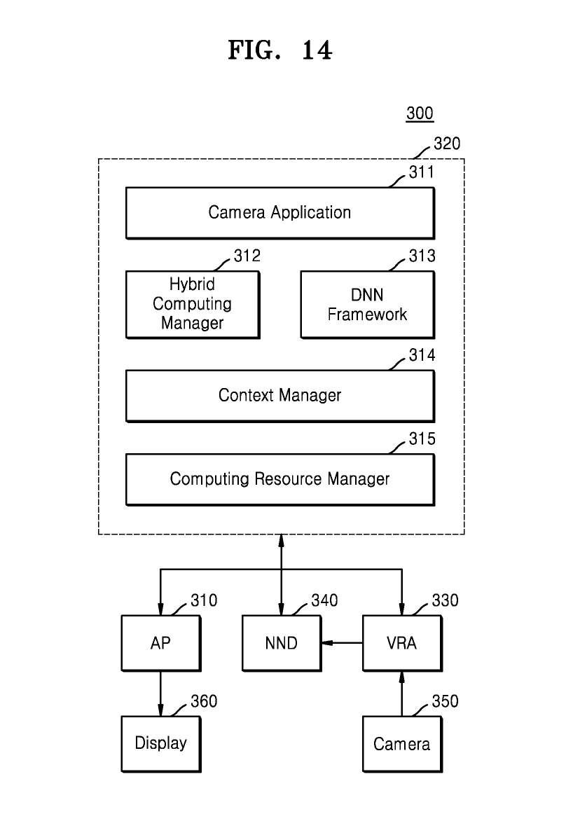

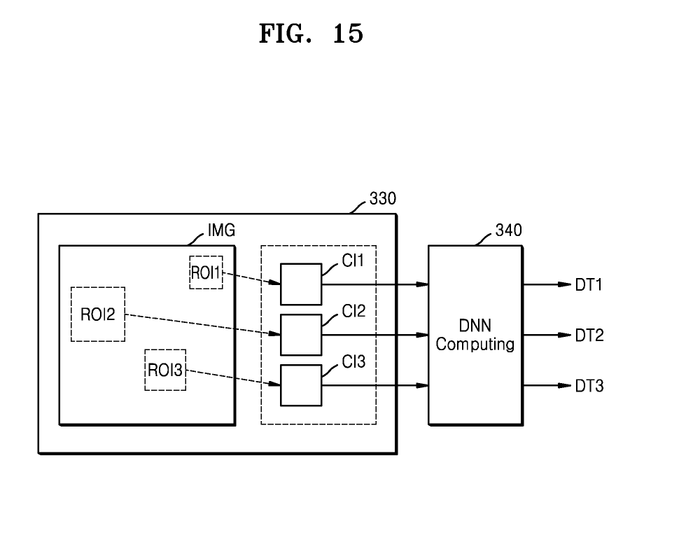

FIG. 14 illustrates an example of a neural network system 300, according to an exemplary embodiment, and FIG. 15 is a diagram for describing a hybrid computation performed in the neural network system 300 of FIG. 14. The neural network system 300 of FIG. 14 may be mounted in an electronic device that senses or tracks an object in an image, based on a neural network computation. For example, the neural network system 300 may be mounted in, but is not limited to, a drone, an autonomous driving device, a smartphone, a camera, a pair of smartglasses, or a surveillance camera.

Referring to FIG. 14, the neural network system 300 includes an AP 310, a hybrid computing module 320, a video recognition accelerator (VRA) 330 (e.g., a video accelerator), a neural network device 340, an image sensor 350, and a display 360. In an embodiment, the video accelerator is a graphics processor or a graphics processing unit.

The hybrid computing module 320 may sense an object in an image of at least one frame provided from the image sensor 350 and may track the object based on a neural network computation.

The hybrid computing module 320 includes a camera application 311, a hybrid computing manager 312, a deep neural network framework 313, a context manager 314, and a computing resource manager 315. The camera application 311, the hybrid computing manager 312, the deep neural network framework 313, the context manager 314, and the computing resource manager 315 are similar to the application 121, the hybrid computing manager 122, the neural network framework 123, the context manager 124, and the computing resource manager 125 that are described above with reference to FIG. 3A. Thus, repeated descriptions thereof are omitted here.

In an exemplary embodiment, the camera application 311, the hybrid computing manager 312, the context manager 314, and the computing resource manager 315 are executed by the AP 310, and a deep neural network model provided from the deep neural network framework 313 is executed by the neural network device 340. However, the inventive concept is not limited thereto, and the camera application 311, the hybrid computing manager 312, the context manager 314, and the computing resource manager 315 may be executed by a separate processor.

Referring to FIGS. 14 and 15, an image IMG generated by the image sensor 350 may be provided as input data to the VRA 330. The VRA 330 is hardware to execute a first algorithm on the image IMG. The first algorithm may extract, from the image IMG, regions of interest ROI1, ROI2, and ROI3 that are expected to include sense-target objects (e.g., a human face, a road, etc.). The VRA 330 may perform a first computation on the received image IMG. Sizes of the regions of interest ROI1, ROI2, and ROI3 may be different from each other. The VRA 330 may perform pre-processing (e.g., image wrapping) on the regions of interest ROI1, ROI2, and ROI3, thereby generating a plurality of candidate images CI1, CI2, and CI3 having a same size. The plurality of candidate images CI1, CI2, and CI3 may be provided to the neural network device 340.

The neural network device 340 is a processor that performs a computation based on a second algorithm (i.e., neural network model). The neural network device 340 may perform a second computation on the plurality of candidate images CI1, CI2, and CI3 received from the VRA 330. The neural network device 340 may be one of a CPU, a GPU, an NPU, and a DSP or may be a dedicated processor for a neural network computation.

The neural network device 340 may perform a computation on the plurality of candidate images CI1, CI2, and CI3, based on a second algorithm (i.e., the deep neural network model) to generate and output computation results (e.g., object sensing results DT1, DT2, and DT3). For example, the object sensing results DT1, DT2, and DT3 may respectively indicate whether a sense-target object is included in the respective regions of interest ROI1, ROI2, and ROI3 or may respectively indicate an object included in the respective regions of interest ROI1, ROI2, and ROI3.

As described above, the hybrid computing manager 312 may check a computing load and a computing capability of the neural network system 300, based on static information and dynamic information provided from the context manager 314 and the computing resource manager 315, and first output information provided from the VRA 330, and may determine, based on the computing load and/or the computing capability, computing parameters (e.g., a size of inputs of a deep neural network model, the number of the inputs, the number of instances of the deep neural network model, or a batch mode of the deep neural network model). The hybrid computing manager 312 may dynamically change the computing parameters based on a computing environment.

For example, the hybrid computing manager 312 may determine the size of inputs of the deep neural network model, based on the number of first outputs (i.e., the number of the plurality of candidate images CI1, CI2, and CI3). For example, when the number of the plurality of candidate images CI1, CI2, and CI3 is increased, the computing load is increased. Thus, the size of inputs of the deep neural network model may be increased. When the number of the plurality of candidate images CI1, CI2, and CI3 is decreased, the computing load is decreased. Thus, the size of inputs of the deep neural network model may be decreased. In an exemplary embodiment, the number of the plurality of candidate images CI1, CI2, and CI3 is compared with one or more reference values, and as a result of the comparison, the size of inputs of the deep neural network model is determined.

The neural network device 340 may parallel-compute at least a portion of the plurality of candidate images CI1, CI2, and CI3, and the number of candidate images that are parallel-processed may be determined based on the computing parameters, as described above with reference to FIGS. 8A through 13.

The camera application 311 may perform a function based on the object sensing results DT1, DT2, and DT3. In an exemplary embodiment, the AP 310 displays, on the display 360, an image generated based on the function of the camera application 311.

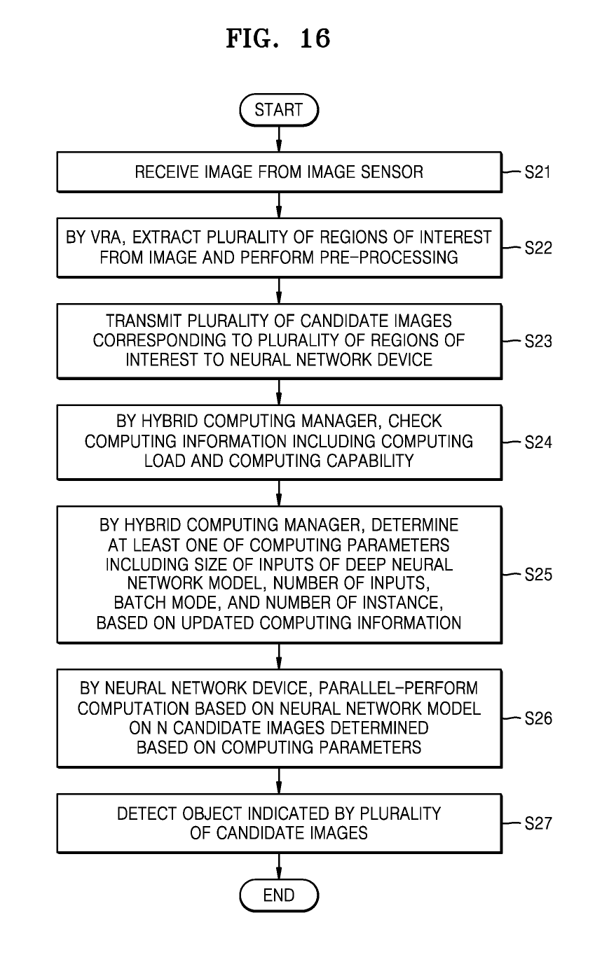

FIG. 16 is a flowchart of an operating method of the neural network system 300 of FIG. 14 according to an exemplary embodiment of the inventive concept.

Referring to FIGS. 14 and 16, the VRA 330 receives an image from the image sensor 350 (S21). The VRA 330 performs a first computation on the received image, based on a first algorithm. The VRA 330 extracts a plurality of regions of interest from the received image, and performs a pre-processing operation on the plurality of extracted regions of interest (S22). The VRA 330 may generate a plurality of candidate images corresponding to the plurality of extracted regions of interest via the pre-processing. By doing so, the computation based on the first algorithm completes. The VRA 330 transmits the plurality of candidate images to the neural network device 340 (S23).

The hybrid computing manager 312 checks computing information (S24). The computing information may include a computing load and a computing capability. The hybrid computing manager 312 may check the computing information, based on static information and dynamic information provided from the context manager 314 and the computing resource manager 315. In an exemplary embodiment, the hybrid computing manager 312 checks the computing information after the computation based on the first algorithm has completed, or periodically checks the computing information. Accordingly, the hybrid computing manager 312 may update the computing information.

The hybrid computing manager 312 determines or changes, based on the updated computing information, at least one of a plurality of computing parameters (e.g., a size of inputs of a deep neural network model, the number of the inputs, a batch mode, and the number of instances) (S25).

The neural network device 340 performs in a parallel manner the computation based on the second algorithm (i.e., the deep neural network model) on N candidate images that are determined based on the computing parameters (S26). That is, neural network device 340 performs a computation based on a deep neural network model on the plurality of candidate images by parallel-processing in units of N candidate images, to generate computation results. Then, the neural network device 340 detects an object indicated by the plurality of candidate images, based on the computation results (S27).

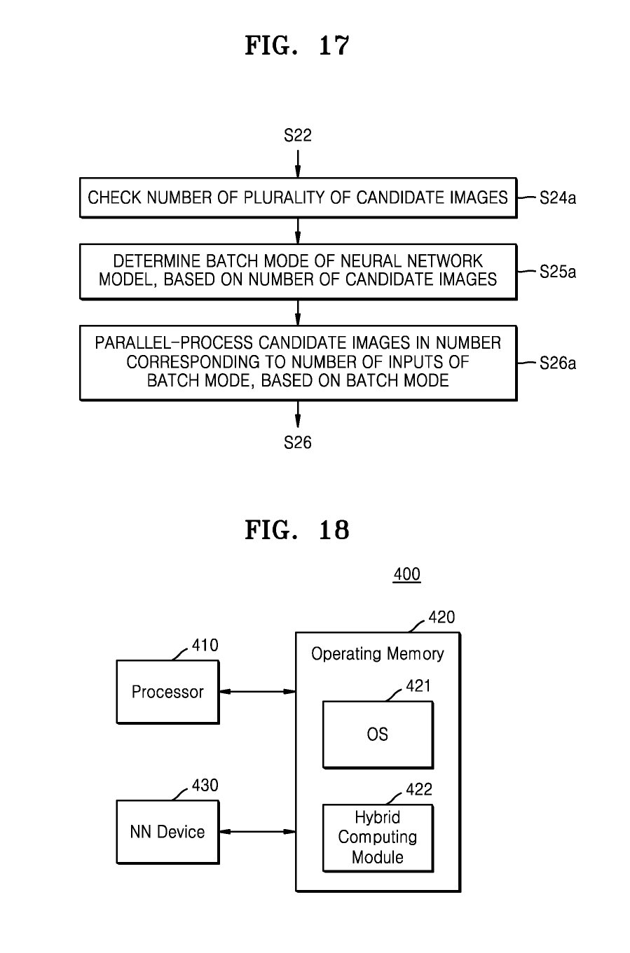

FIG. 17 is a flowchart of an example embodiment of S24, S25 and S26 in the flowchart of FIG. 16.

Referring to FIG. 17, the hybrid computing manager 312 checks the number of the plurality of candidate images (S24a). The hybrid computing manager 312 may determine the computing load, based on the number of the plurality of candidate images. The hybrid computing manager 312 may determine a batch mode of a neural network model, based on the number of the plurality of candidate images (S25a). When the number of the plurality of candidate images is large, the hybrid computing manager 312 may set the batch mode to be high, and when the number of the plurality of candidate images is small, the hybrid computing manager 312 may set the batch mode to be low. In an exemplary embodiment, the hybrid computing manager 312 sets the batch mode by taking into account the number of the plurality of candidate images and the computing capability.

The neural network device 340 parallel-processes candidate images in a number corresponding to the number of inputs of the batch mode, based on the batch mode (S26a). As described above with reference to FIG. 12, the neural network device 340 may perform a computation based on one layer on the plurality of candidate images to generate output results, and may perform a computation based on a next layer on the output results.

FIG. 18 is a block diagram of a hybrid computing module that is implemented as software, according to an exemplary embodiment of the inventive concept. A system illustrated in FIG. 18 may be an AP 400, and the AP 400 may be embodied as a system on chip (SoC) as a semiconductor chip.

The AP 400 includes a processor 410 and an operation memory 420. Although not illustrated in FIG. 18, the AP 400 may further include one or more intellectual property (IP) modules, cores, or blocks connected to a system bus. An IP core is a reusable unit of lock or integrated circuit. The operation memory 420 may store software such as various programs and instructions associated with an operation of a system in which the AP 400 is used. For example, the operation memory 420 may include an OS 421 and a hybrid computing module 422. The hybrid computing module 422 may perform a hybrid computation based on heterogeneous algorithms. For example, the hybrid computation may include execution of a first algorithm that is a pre-processing algorithm, and a second algorithm that is a deep neural network model. The hybrid computing module 422 may include a hybrid computing manager. According to the aforementioned embodiments, the hybrid computing manager may determine computing parameters, based on a computing load and a computing capability. Accordingly, when the second algorithm is performed, inputs may be parallel-processed.

According to an exemplary embodiment, the hybrid computing module 422 is implemented in the OS 421.

Although FIG. 18 illustrates one processor 410, the AP 400 may include a plurality of processors. In this regard, one of the plurality of processors may be a dedicated processor to perform the first algorithm.

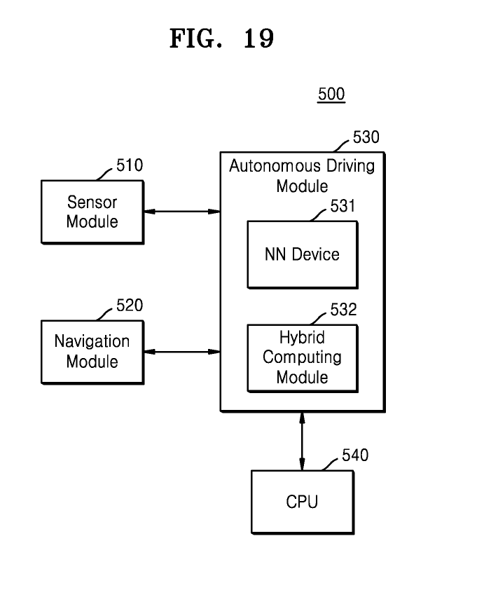

FIG. 19 is a block diagram of an autonomous driving system 500, according to an exemplary embodiment of the inventive concept. The autonomous driving system 500 includes a sensor module 510, a navigation module 520, an autonomous driving module 530, and a CPU 540. The autonomous driving module 530 includes a neural network device 531 and a hybrid computing module 532.

The neural network device 531 may perform a neural network operation using various video information and voice information, and may generate an information signal such as a video recognition result or a voice recognition result, based on a result of a performance. For example, the sensor module 510 may include devices such as a camera or a microphone capable of capturing various video information and voice information, and may provide the various video information and voice information to the autonomous driving module 530. The navigation module 520 may provide various types of information (e.g., location information, speed information, breaking information, etc.) related to vehicle driving to the autonomous driving module 530. The neural network device 531 may receive an input of information from the sensor module 510 and/or the navigation module 520, and then may execute various types of neural network models, thereby generating the information signal.

The hybrid computing module 532 may perform a hybrid computation based on a heterogeneous algorithm. The hybrid calculation may include a first algorithm that is a pre-processing algorithm, and a second algorithm that is a deep neural network model. The hybrid computing module 532 may include a hybrid computing manager. According to the aforementioned embodiments, the hybrid computing manager may determine computing parameters, based on a computing load and a computing capability. Accordingly, when the second algorithm is performed, inputs may be parallel-processed.

A conventional system processes inputs (i.e., outputs a first operation based on a pre-processing algorithm) sequentially when performing a neural network operation while a hybrid algorithm including the neural network operation is processed. Thus, a latency of the conventional system has increased.

In contrast, the neural network system configured to execute a hybrid algorithm including a pre-processing algorithm and a neural network algorithm according to embodiments of the inventive concept, processes inputs (i.e. outputs a first operation based on a pre-processing algorithm) in parallel, when performing a neural network operation. The neural network system dynamically determine the number of operational parameters of a neural network operation, i.e. the number of outputs of the first operation to be processed in parallel, based on computing load, computing capacity, and the like.

Therefore, according to the neural network system and the operation method thereof, that is, the neural network operation based on the parallel processing according to embodiments of the inventive concept, latency of the neural network system may be reduced and processing speed of the neural network system may be increased. Thus, the computing function and performance of the neural network system may be improved over conventional systems.

While the inventive concept has been particularly shown and described with reference to exemplary embodiments thereof, by using particular terms, it will be understood by those of ordinary skill in the art that various changes in form and details may be made therein without departing from the spirit and scope of the inventive concept.

1. A neural network system configured to perform a parallel-processing operation, the neural network system comprising:
a first processor configured to generate a plurality of first outputs by performing a first computation based on a first algorithm on input data,
a memory storing a first program configured to determine a computing parameter in an adaptive manner based on at least one of a computing load and a computing capability of the neural network system; and
a second processor configured to perform the parallel-processing operation to perform a second computation based on a second algorithm on at least two first outputs from among the plurality of first outputs, based on the computing parameter.

2. The neural network system of claim 1, wherein the second algorithm comprises a neural network model.

3. The neural network system of claim 1, wherein the computing parameter comprises at least one of a size of inputs of the neural network model, a number of the inputs, a number of instances of the neural network model, and a batch mode of the neural network model.

4. The neural network system of claim 2, wherein the first processor is a dedicated processor designed to perform the first algorithm.

5. The neural network system of claim 2, wherein the memory stores a second program that executes the second algorithm.

6. A method of operating a neural network system comprising a computing device for performing a hybrid computation, the method comprising:
performing, by the computing device, a first computation on a first input for generating a plurality of first outputs;
determining, by the computing device, a computing parameter based on computing information of the system;
determining, by the computing device, N candidates from the first outputs based on the computing parameter, where N>=2; and
performing, by the computing device, a second computation on the N candidates by performing a parallel-processing operation on the N candidates using a neural network model.

7. The method of claim 6, wherein the computing parameter comprises at least one of a size of inputs of the neural network model, a number of the inputs, a number of instances of the neural network model, and an batch mode of the neural network model.

8. The method of claim 7, wherein each of the plurality of first outputs has a first size, and the determining of the computing parameter comprises determining the size of the inputs to be K times the first size, where K>=1.

9. The method of claim 8, wherein a size of outputs of the neural network model is K times a size of the outputs when the size of the inputs is equal to the first size.

10. The method of claim 7, wherein the determining of the computing parameter comprises determining the size of the inputs of the neural network model to be equal to a size of the plurality of first outputs, and determining the number of the instances of the neural network model to be a multiple number.

11. The method of claim 7, wherein the determining of the computing parameter comprises determining the batch mode based on the computing information, and determining the number of the inputs based on the batch mode.

12. The method of claim 7, wherein the neural network model comprises a plurality of layers, and the performing of the second computation comprises:
generating N first computation outputs by performing a first sub operation on the N candidates, the first sub operation corresponding to a first layer from among the plurality of layers; and
generating N second computation outputs by performing a second sub operation on the N first computation outputs, the second sub operation corresponding to a second layer from among the plurality of layers.

13. The method of claim 6, wherein the determining of the computing parameter comprises determining the computing parameter based on at least one of a computing load and a computing capability of the neural network system.

14. The method of claim 13, wherein
the computing load comprises at least one of a number of the plurality of first outputs, a dimension of each of the plurality of first outputs, a capacity and power of a memory required for processing based on the neural network model, and a data processing speed required by the neural network system, and
the computing capability comprises at least one of usable power, a usable hardware resource, a usable memory capacity, a system power state, and a remaining quantity of a battery which are associated with the neural network system.

15. The method of claim 6, wherein the computing device comprises heterogeneous first and second processors, and the first computation is performed by the first processor, and the second computation is performed by the second processor.

16-22. (canceled)

23. A neural network system for processing image data to determine an object, the system comprising:
an image sensor configured to capture an image;
a video recognition accelerator to extract regions of interest from the image to generate a plurality of candidate images; and
a processor performing a parallel-processing operation on a subset of the candidate images using a neural network model to generate computation results indicating whether the object is present.

24. The neural network system of claim 23, wherein a size of the neural network model is proportional to a number of the candidate images.

25. The neural network system of claim 23, wherein the system determines the subset based on a computing load of the system.

26. The neural network system of claim 23, wherein the system determines the subset based on a computing capability of the system.
